(19) United States
(12) Patent Application Publication
(10) Pub. No.: US 2025/0208350 A1
(43) Pub. Date: Jun. 26, 2025

(54) OPTICAL FIBER POSITIONING COMPONENT, AND OPTICAL FIBER FUSION SPLICING MACHINE

(71) Applicant: SUMITOMO ELECTRIC OPTIFRONTIER CO., LTD., Yokohama-shi, Kanagawa (JP)

(72) Inventors: Tomoyoshi SASAKI, Yokohama-shi, Kanagawa (JP); Kazufumi JOKO, Yokohama-shi, Kanagawa (JP); Ryuichiro SATO, Yokohama-shi, Kanagawa (JP); Akira ONODERA, Kurihara City, Miyagi (JP)

(21) Appl. No.: 18/846,307

(22) PCT Filed: Mar. 13, 2023
(86) PCT No.: PCT/JP2023/009606

§ 371 Date: Sep. 12, 2024

(30) Foreign Application Priority Data
Mar. 17, 2022 (JP) 2022-042680

(51) Int. Cl. G02B 6/255

(52) U.S. Cl. CPC G02B 6/2556; G02B 6/2553

(57) ABSTRACT

An optical fiber positioning component is installed in an optical fiber fusion splicing machine to position an optical fiber on a plane intersecting a central axis of the optical fiber. The optical fiber positioning component comprises: a ceramic base having a V-groove; a metal layer which is provided on the base and which is in contact with the base, at least inside the V-groove, and which includes at least one metal selected from the group comprising Cr, Ti, Ta and Nb; an oxide layer which is provided on the metal layer and which is in contact with the metal layer; and a water-repellent and oil-repellent coating layer which is provided on the oxide layer and which is in contact with the oxide layer. The optical fiber positioning component positions the optical fiber by the coating layer on the inside of the V-groove coming into contact with the optical fiber.

### TECHNICAL FIELD

The present disclosure relates to an optical fiber positioning member and an optical fiber fusion splicer. This application claims priority based on Japanese Patent Application No. 2022-042680 filed on Mar. 17, 2022, and the entire contents of the Japanese Patent Application are incorporated herein by reference.

### BACKGROUND ART

Patent Literature 1 discloses a technique related to a laser fusion-splicing jig. The laser fusion-splicing jig is a jig for fusion-splicing optical fibers, and includes a V-groove plate having a V-shaped groove for placing the optical fibers. The V-groove plate is made of quartz, ruby, sapphire, or zirconia. The V-groove plate is coated with titanium dioxide.

### CITATION LIST

### Patent Literature

Patent Literature 1: Japanese Unexamined Patent Application Publication No. 2011-158728

### SUMMARY OF INVENTION

### Technical Problem to be Solved by Invention

As described in Patent Literature 1, when two optical fibers are fusion-spliced to each other, a member having a V-groove is used to position each optical fiber. Each optical fiber is accommodated in the V-groove and is positioned in a plane intersecting with the center axis of each optical fiber by coming in contact with a pair of inclined surfaces of the V-groove. In such a configuration, when dirt adheres to the inside of the V-groove, the position of each optical fiber is shifted by the thickness of the dirt, and thus the positioning precision of each optical fiber is reduced.

An object of the present disclosure is to provide an optical fiber positioning member and an optical fiber fusion splicer in which dirt can be made less likely to adhere to the inside of a V-groove for positioning an optical fiber.

### Solution to Problem

An optical fiber positioning member according to an embodiment is a member that is installed in an optical fiber fusion splicer and positions an optical fiber in a plane intersecting a central axis of the optical fiber. The optical fiber positioning member includes a substrate made of a ceramic, a metal layer, an oxide layer, and a coating layer. The substrate has a V-groove extending straight. The metal layer is disposed on the substrate at least inside the V-groove to be in contact with the substrate. The metal layer contains at least one metal selected from the group consisting of chromium, titanium, tantalum, and niobium. The oxide layer is disposed on the metal layer to be in contact with the metal layer. The coating layer is disposed on the oxide layer to be in contact with the oxide layer. The coating layer has water repellency and oil repellency. The coating layer inside the V-groove comes in contact with the optical fiber to thereby position the optical fiber.

### Advantageous Effects of Invention

In the optical fiber positioning member and the optical fiber fusion splicer according to the present disclosure, dirt can be made less likely to adhere to the inside of the V-groove.

### BRIEF DESCRIPTION OF DRAWINGS

FIG. 1 is a perspective view showing an appearance of an optical fiber fusion splicer according to an embodiment of the present disclosure.

FIG. 2 is a perspective view showing an appearance of an optical fiber fusion splicer according to an embodiment of the present disclosure.

FIG. 3 is an enlarged perspective view showing two optical fiber positioning members.

FIG. 4 is an enlarged perspective view showing one of the two optical fiber positioning members.

FIG. 5 is an enlarged perspective view showing one of the two optical fiber positioning members.

FIG. 6 is a view showing a cross section of a V-groove perpendicular to an extending direction of the V-groove.

FIG. 7 is a perspective view showing a state in which an optical fiber is accommodated in a V-groove.

FIG. 8 is a view showing a cross section structure of a multi-layer film.

FIG. 9 is an enlarged perspective view showing an optical fiber positioning member according to a modification.

FIG. 10 is an enlarged perspective view showing an optical fiber positioning member according to another modification.

### DESCRIPTION OF EMBODIMENTS

### Description of Embodiments of Present Disclosure

First, the contents of embodiments according to the present disclosure will be listed and described.

An embodiment of the present disclosure is a member that is installed in an optical fiber fusion splicer and positions an optical fiber in a plane intersecting a central axis of the optical fiber. The optical fiber positioning member includes a substrate made of a ceramic, a metal layer, an oxide layer, and a coating layer. The substrate has a V-groove extending straight. The metal layer is disposed on the substrate at least inside the V-groove to be in contact with the substrate. The metal layer contains at least one metal selected from the group consisting of chromium, titanium, tantalum, and niobium. The oxide layer is disposed on the metal layer to be in contact with the metal layer. The coating layer is disposed on the oxide layer to be in contact with the oxide layer. The coating layer has water repellency and oil repellency. The coating layer inside the V-groove comes in contact with the optical fiber to thereby position the optical fiber.

In this optical fiber positioning member, the metal layer, the oxide layer, and the coating layer are stacked on or above a substrate at least inside the V-groove. The coating layer can make less likely for dirt to adhere to the inside of the V-groove. The oxide layer has a high affinity with the coating layer and thus can be firmly bonded to the coating layer. However, when the oxide layer is brought into contact with the ceramic substrate, the coating layer and the oxide layer are easily separated from the substrate because the adhesion between oxide and ceramic is low. Thus, in the optical fiber positioning member, the metal layer containing at least one metal selected from the group consisting of chromium (Cr), titanium (Ti), tantalum (Ta), and niobium (Nb) is disposed between the oxide layer and the substrate. The present inventors have made a prototype of such a structure, and have found that the metal layer is less likely to be separated from the substrate, and the oxide layer is less likely to be separated from the metal layer. That is, in the optical fiber positioning member, dirt can be made less likely to adhere to the inside of the V-groove, and the effect can be maintained for a long period of time.

In the optical fiber positioning member, the metal layer may be a chromium layer, a titanium layer, a tantalum layer, or a niobium layer. With such a configuration, the metal layer can be easily formed from a material containing a single element.

In the optical fiber positioning member, the metal layer may have a thickness of 50 nm or more and 200 nm or less. In this case, sufficient adhesion can be achieved between the substrate and the oxide layer.

In the optical fiber positioning member, the substrate may further have a first surface and a second surface whose normals are parallel to each other. The V-groove may be located between the first surface and the second surface. The first surface may have a first portion including an edge closer to the V-groove on the first surface. The second surface may have a second portion including an edge closer to the V-groove on the second surface. The metal layer, the oxide layer, and the coating layer may be also disposed on the first portion and the second portion. In this case, dirt can be made less likely to adhere even in a vicinity of the V-groove, and it is possible to further prevent dirt from adhering to the inside of the V-groove.

In the optical fiber positioning member, the first surface may further have a third portion disposed such that the first portion is located between the V-groove and the third portion. The second surface may further have a fourth portion disposed such that the second portion is located between the V-groove and the fourth portion. None of the metal layer, the oxide layer, and the coating layer may be disposed on the third portion and the fourth portion. In this case, the surface of the ceramic substrate is exposed. The light reflectance of the ceramic surface is higher than the light reflectance of the stacked structure including the metal layer, the oxide layer, and the coating layer (mainly depending on the light reflectance of the metal layer). Thus, the light reflectance of the third portion and the fourth portion is higher than the light reflectance of the V-groove, the first portion, and the second portion. Thus, when the optical fiber is accommodated in the V-groove, the optical fiber positioning member is illuminated by using a light source, so that the position of the V-groove can be easily confirmed by visual observation, and work efficiency can be enhanced.

In the optical fiber positioning member, the substrate may further have a first surface and a second surface between which the V-groove is located and whose normals are parallel to each other, a first protruding portion formed side by side with the first surface in an extending direction of the V-groove, and a second protruding portion formed side by side with the second surface in the extending direction and disposed such that the V-groove is located between the first protruding portion and the second protruding portion. The first protruding portion may have an inclined surface continuous from the V-groove. The inclined surface of the first protruding portion may have a fifth portion including an edge closer to the V-groove on the inclined surface of the first protruding portion. The second protruding portion may have an inclined surface continuous from the V-groove. The inclined surface of the second protruding portion may have a sixth portion including an edge closer to the V-groove on the inclined surface of the second protruding portion. The metal layer, the oxide layer, and the coating layer may be also disposed on the fifth portion and the sixth portion. In this case, dirt can be made less likely to adhere even in a vicinity of the V-groove, and it is possible to further prevent dirt from adhering to the inside of the V-groove. In addition, the first protruding portion and the second protruding portion have the inclined surface continuous from the V-groove, and thus the optical fiber is easily accommodated in the V-groove.

In the optical fiber positioning member, the inclined surface of the first protruding portion may further have a seventh portion disposed such that the fifth portion is located between the V-groove and the seventh portion. The inclined surface of the second protruding portion may further have an eighth portion disposed such that the sixth portion is located between the V-groove and the eighth portion. None of the metal layer, the oxide layer, and the coating layer may be disposed on the seventh portion and the eighth portion. In this case, as in the case where the metal layer, the oxide layer, and the coating layer are not disposed in the third portion and the fourth portion, the position of the V-groove can be easily confirmed by visual observation, and work efficiency can be enhanced.

In the optical fiber positioning member, the oxide layer may be a silicon dioxide layer. For example, with such a configuration, the oxide layer can be firmly bonded to the coating layer.

In the optical fiber positioning member, the oxide layer may have an anti-reflection function. In this case, the position of the V-groove can be easily confirmed by visual observation, and work efficiency can be improved.

In the optical fiber positioning member, the oxide layer may have a thickness of 50 nm or more and 200 nm or less.

In the optical fiber positioning member, the coating layer may be formed of a fluorine-based resin. For example, such a configuration can make less likely for dirt to adhere to the inside of the V-groove.

In the optical fiber positioning member, the coating layer may have a thickness of 5 nm or more and 30 nm or less.

In the optical fiber positioning member, the substrate may further have another V-groove extending in parallel with the V-groove. The metal layer may be also disposed on the substrate inside the another V-groove to be in contact with the substrate. The coating layer inside the another V-groove may come in contact with another optical fiber to thereby position the another optical fiber. As described above, the substrate has a plurality of V-grooves, and thus fusion splicing work of a plurality of optical fibers can be performed at the same time, and thus work efficiency is improved.

An embodiment of the present disclosure is an optical fiber fusion splicer. The optical fiber fusion splicer includes any one of the optical fiber positioning members. In the optical fiber fusion splicer, since dirt is less likely to adhere to the inside of the V-groove for positioning the optical fiber to be fusion-spliced, connection failure can be reduced.

### Details of Embodiments of Present Disclosure

Hereinafter, embodiments of an optical fiber positioning member and an optical fiber fusion splicer according to the present disclosure will be described in detail with reference to the accompanying drawings. The present invention is not limited to these examples, but is defined by the scope of the claims, and is intended to include all the modifications within the scope and meaning equivalent to the scope of the claims. In the following description, the same elements are denoted by the same reference numerals in the description of the drawings, and redundant description will be omitted.

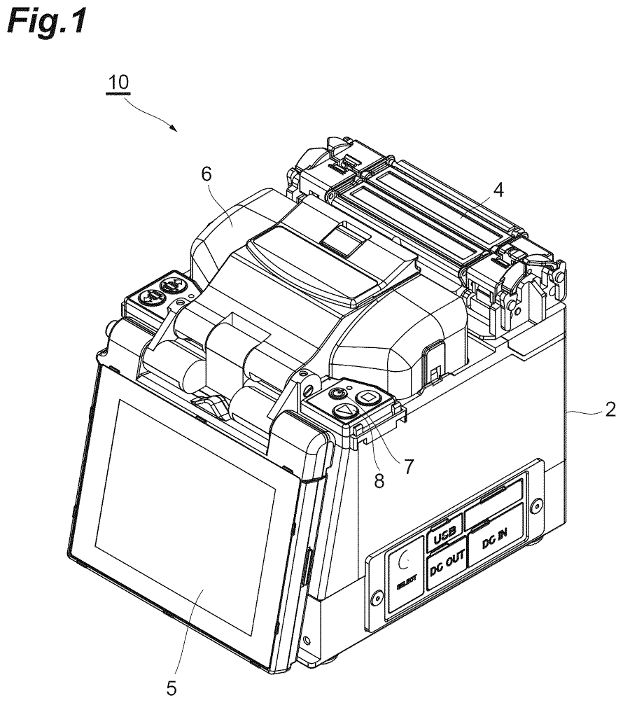

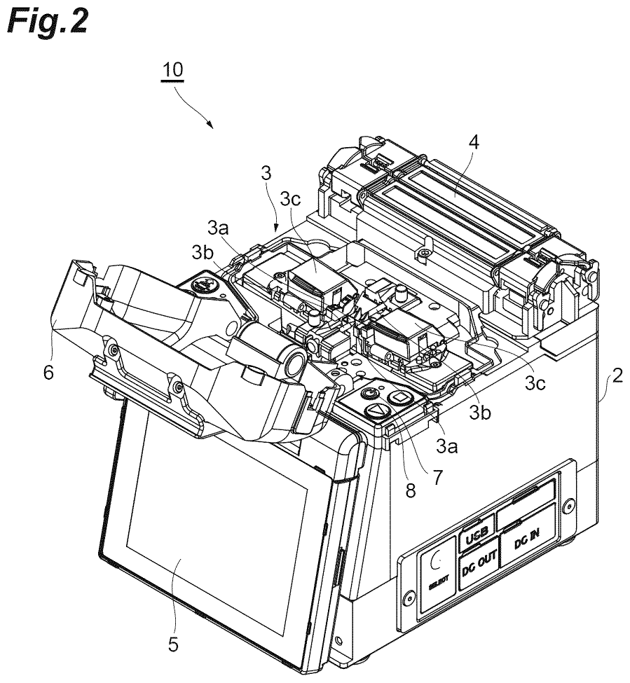

FIG. 1 and FIG. 2 are perspective views showing an appearance of an optical fiber fusion splicer 10 according to an embodiment of the present disclosure. FIG. 1 shows the appearance with a windshield cover closed. FIG. 2 shows the appearance with the windshield cover opened to reveal an internal structure of the optical fiber fusion splicer 10. Optical fiber fusion splicer 10 is a device for fusion-splicing optical fibers to each other by electric discharge, and includes a box-shaped housing 2 as shown in FIG. 1 and FIG. 2. A fusion splicing unit 3 for fusion-splicing optical fibers to each other and a heating device 4 are disposed on the upper part of housing 2. Heating device 4 heats and contracts a fiber reinforcement sleeve to be put on a fusion-spliced portion of optical fibers. Optical fiber fusion splicer 10 further includes a monitor 5, a windshield cover 6, a power switch 7, and a splicing start switch 8. Monitor 5 is a display section in the embodiment of the present disclosure, and displays various kinds of information. The various kinds of information include, for example, a fusion splicing state of optical fibers whose image is captured by a camera disposed inside housing 2. Windshield cover 6 prevents wind from entering fusion splicing unit 3. Power switch 7 is a push button for switching ON/OFF of the power of optical fiber fusion splicer 10 in response to an operation of a user. Splicing start switch 8 is a push button for starting a fusion splicing operation of optical fibers in response to an operation of a user.

As shown in FIG. 2, fusion splicing unit 3 includes two optical fiber positioning members 3a, two electrode rods 3b, and holder placement portions on which two optical fiber holders 3c can be placed. Each of two optical fibers to be fusion-spliced is held and fixed in a corresponding optical fiber holder of two optical fiber holders 3c. Each of the two optical fiber holders is placed and fixed on a corresponding holder placement portion of the two holder placement portions. Two optical fiber positioning members 3a are disposed between two optical fiber holders 3c. Each of optical fiber positioning members 3a positions an optical fiber held by the corresponding optical fiber holder 3c in a plane intersecting the center axis of the optical fiber. Two electrodes rods 3b are disposed between two optical fiber positioning members 3a so that the line segment connecting electrode rods 3b intersects with an arrangement direction of two optical fiber positioning members 3a. Two electrode rods 3b fusion-splice the tip ends of the two optical fibers to each other by arc discharge.

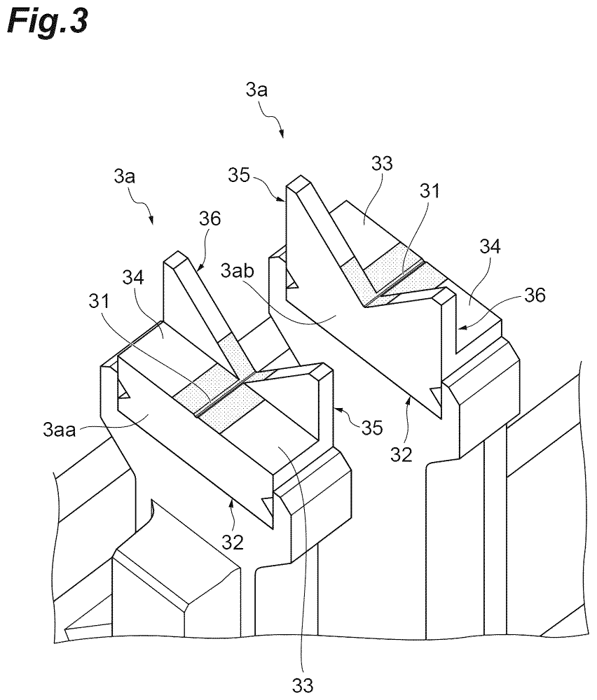

FIG. 3 is an enlarged perspective view showing two optical fiber positioning members 3a. Each of these optical fiber positioning members 3a has a V-groove 31 extending straight. Two V-grooves 31 are located on a common axis extending straight. These optical fiber positioning members 3a have the same shape and face each other in opposite directions.

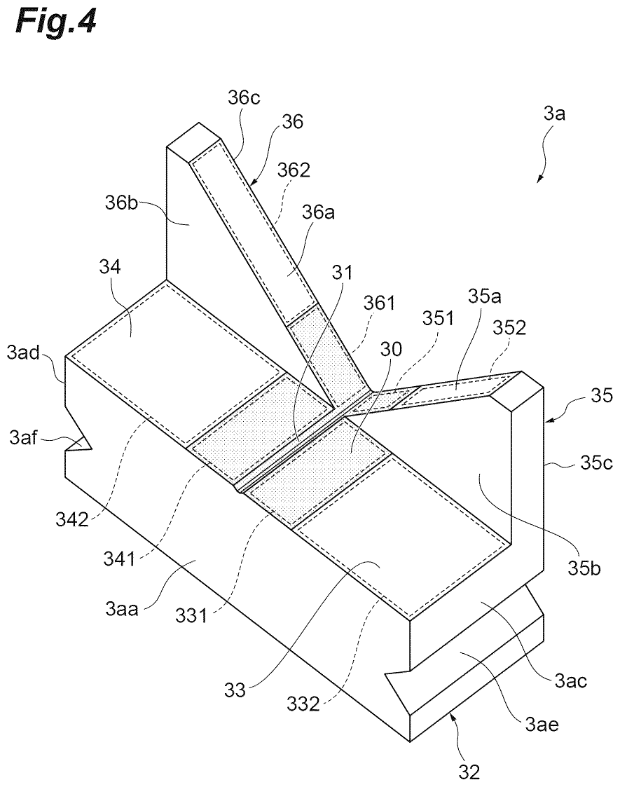

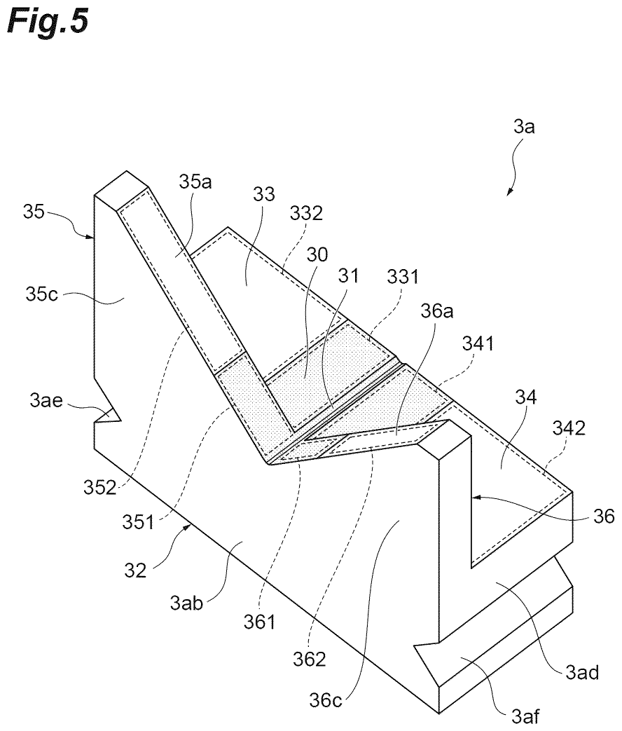

FIG. 4 and FIG. 5 are enlarged perspective views showing one of two optical fiber positioning members 3a. FIG. 4 is a perspective view including an end surface 3aa of optical fiber positioning member 3a. FIG. 5 is a perspective view including an end surface 3ab of optical fiber positioning member 3a. As shown in FIG. 4 and FIG. 5, optical fiber positioning member 3a includes a substrate 32 and a multi-layer film 30. In FIG. 4 and FIG. 5, the range in which multi-layer film 30 is disposed is indicated by halftone dot.

Substrate 32 is made of ceramic, and is made of, for example, zirconia. Substrate 32 has V-groove 31, a flat first surface 33, a flat second surface 34, a first protruding portion 35, and a second protruding portion 36. Substrate 32 further includes end surface 3aa, end surface 3ab, a side surface 3ac, and a side surface 3ad.

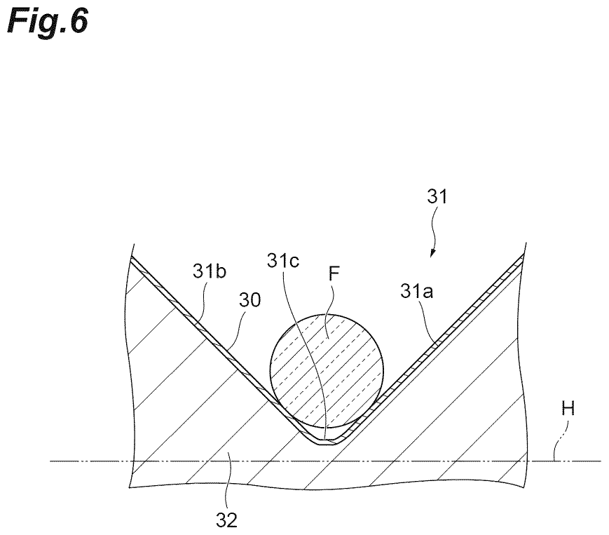

FIG. 6 is a view showing a cross section of V-groove 31 perpendicular to the extending direction of V-groove 31. As shown in FIG. 6, V-groove 31 has two inclined surfaces 31a and 31b. Inclined surfaces 31a and 31b are inclined in different directions with respect to an imaginary plane H along the extending direction of V-groove 31. Inclined surfaces 31a and 31b have the same inclination angle with respect to imaginary plane H. The normal vector of inclined surface 31a intersects the normal vector of inclined surface 31b. In the bottom portion of V-groove 31, the part where inclined surface 31a is connected to inclined surface 31b is a curved surface 31c. In the other parts except for curved surface 31c, inclined surfaces 31a and 31b are flat.

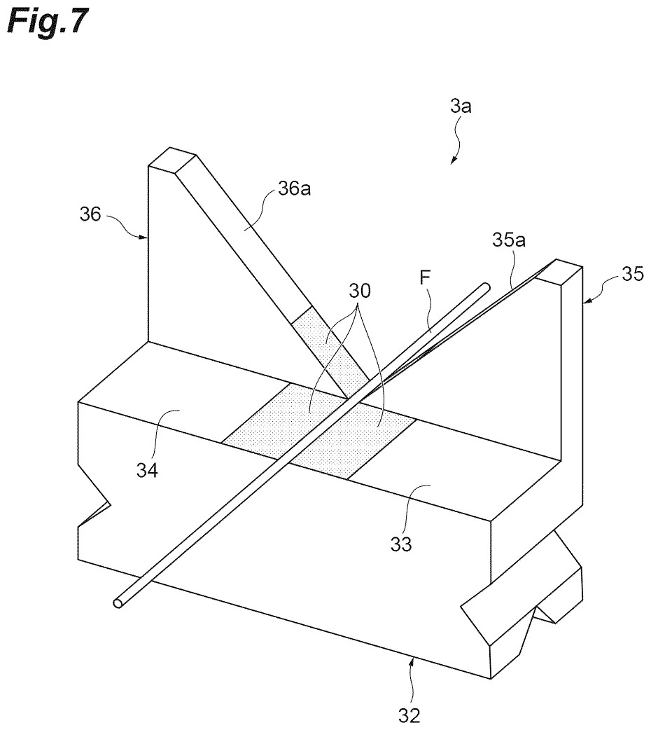

An optical fiber F is accommodated in V-groove 31, and is thereby positioned in a plane perpendicular to the center axis of optical fiber F, in other words, in a plane perpendicular to the extending direction of V-groove 31. At this time, optical fiber F is in contact with both multi-layer film 30 disposed on inclined surface 31a and multi-layer film 30 disposed on inclined surface 31b. FIG. 7 is a perspective view showing a state in which optical fiber F is accommodated in V-groove 31.

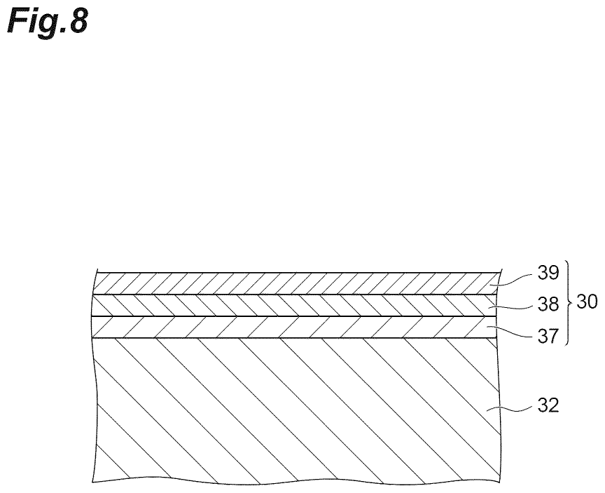

FIG. 8 is a view showing a cross section structure of multi-layer film 30. As shown in FIG. 8, multi-layer film 30 includes a metal layer 37, an oxide layer 38, and a coating layer 39.

Metal layer 37 is disposed on substrate 32 to be in contact with substrate 32. Metal layer 37 contains at least one metal selected from the group consisting of chromium (Cr), titanium (Ti), tantalum (Ta), and niobium (Nb). For example, metal layer 37 is a Cr layer, a Ti layer, a Ta layer, or an Nb layer. Metal layer 37 has a thickness of 50 nm or more and 200 nm or less, for example. Metal layer 37 may be formed by, for example, physical vapor deposition of a constituent material on substrate 32.

Oxide layer 38 is disposed on metal layer 37 to be in contact with metal layer 37. That is, metal layer 37 is sandwiched between substrate 32 and oxide layer 38. Oxide layer 38 is, for example, a silicon-dioxide (SiO₂) layer. Oxide layer 38 may have an anti-reflection function. Oxide layer 38 has a thickness of 50 nm or more and 200 nm or less, for example. Oxide layer 38 may be formed by, for example, vapor deposition of a constituent material on metal layer 37.

Coating layer 39 is disposed on oxide layer 38 to be in contact with oxide layer 38. Coating layer 39 has water repellency and oil repellency. Coating layer 39 is formed of, for example, fluorine-based resin (thermoplastic polymer). In one example, coating layer 39 contains fluorine-based polymer in a range of 15 wt % to 25 wt %, ethyl nonafluorobutyl ether in a range of 25 wt % to 35 wt %, and ethyl nonafluoroisobutyl ether in a range of 45 wt % to 55 wt %. In one example, coating layer 39 is composed of only fluorine-based polymer, ethyl nonafluorobutyl ether, and ethyl nonafluoroisobutyl ether. Coating layer 39 may be formed by, for example, applying a constituent material onto oxide layer 38 and curing the constituent material. Coating layer 39 forms exposed surfaces of the inside of V-groove 31, that is, inclined surface 31a, inclined surface 31b, and curved surface 31c, and positions optical fiber F by coming into contact with optical fiber F. Coating layer 39 has a thickness of 5 nm or more and 30 nm or less, for example.

As shown in FIG. 4 and FIG. 5, multi-layer film 30 is formed in a limited manner even in a vicinity of V-groove 31. That is, multi-layer film 30 is also disposed in the parts adjacent to V-groove 31 on first surface 33 and second surface 34, and the parts adjacent to V-groove 31 on an inclined surface 35a and an inclined surface 36a.

First surface 33 and second surface 34 of substrate 32 are located on both sides of V-groove 31 with V-groove 31 interposed therebetween. That is, V-groove 31 is located between first surface 33 and second surface 34. First surface 33 is located on one side of V-groove 31 in a direction intersecting with the extending direction of V-groove 31. Second surface 34 is located on the other side of V-groove 31 in the same direction. First surface 33 is connected to inclined surface 31a of V-groove 31 (see FIG. 6). Second surface 34 is connected to inclined surface 31b of V-groove 31 (see FIG. 6). The normal of first surface 33 is parallel to the normal of second surface 34. Specifically, first surface 33 and second surface 34 extend along imaginary plane H (see FIG. 6) and are flush with each other.

First surface 33 has a first portion 331 extending along V-groove 31. First portion 331 is adjacent to inclined surface 31a of V-groove 31. First portion 331 includes an edge of first surface 33 closer to V-groove 31, that is, a boundary line between first surface 33 and inclined surface 31a. Second surface 34 has a second portion 341 extending along V-groove 31. Second portion 341 is adjacent to inclined surface 31b of V-groove 31. Second portion 341 includes an edge of second surface 34 closer to V-groove 31, that is, a boundary line between second surface 34 and inclined surface 31b.

Multi-layer film 30 shown in FIG. 8 is also disposed on first portion 331 and second portion 341. Thus, the surface of optical fiber positioning member 3a in first portion 331 and second portion 341 is formed of coating layer 39. The configurations of metal layer 37, oxide layer 38, and coating layer 39 disposed on first portion 331 and second portion 341 are the same as the configurations of those disposed inside V-groove 31 in terms of, for example, material, thickness, and manufacturing method.

First surface 33 further has a third portion 332. Third portion 332 is disposed such that first portion 331 is located between V-groove 31 and third portion 332. That is, first portion 331 is located between third portion 332 and V-groove 31. Third portion 332 is located opposite to V-groove 31 with respect to first portion 331, and is not adjacent to V-groove 31. Second surface 34 further has a fourth portion 342. Fourth portion 342 is disposed such that second portion 341 is located between V-groove 31 and fourth portion 342. That is, second portion 341 is located between fourth portion 342 and V-groove 31. Fourth portion 342 is located opposite to V-groove 31 with respect to second portion 341, and is not adjacent to V-groove 31.

Multi-layer film 30 is not disposed on third portion 332, and is not disposed on fourth portion 342. Thus, the surface of optical fiber positioning member 3a in third portion 332 and fourth portion 342 is formed of substrate 32. In other words, substrate 32 is exposed from multi-layer film 30 in third portion 332 and fourth portion 342.

First protruding portion 35 of substrate 32 is formed side by side with first surface 33 in the extending direction of V-groove 31. First protruding portion 35 protrudes from an imaginary plane including first surface 33 in a normal direction of first surface 33. First protruding portion 35 has inclined surface 35a continuous from V-groove 31 and end surfaces 35b and 35c facing each other in the extending direction of V-groove 31. Inclined surface 35a is inclined in the same direction as inclined surface 31a of V-groove 31 with respect to imaginary plane H (see FIG. 6), and is flat. In one example, the inclined angle of inclined surface 35a is the same as the inclined angle of inclined surface 31a of V-groove 31. End surfaces 35b and 35c extend along an imaginary plane intersecting the extending direction of V-groove 31.

Second protruding portion 36 of substrate 32 is formed side by side with second surface 34 in the extending direction of V-groove 31. Second protruding portion 36 protrudes from an imaginary plane including second surface 34 in a normal direction of second surface 34. Second protruding portion 36 has inclined surface 36a continuous from V-groove 31, and end surfaces 36b and 36c facing each other in the extending direction of V-groove 31. Inclined surface 36a is inclined in the same direction as inclined surface 31b of V-groove 31 with respect to imaginary plane H (see FIG. 6), and is flat. In one example, the inclined angle of inclined surface 36a is the same as the inclined angle of inclined surface 31b of V-groove 31. Inclined surface 36a forms a V-shaped wall together with the above-described inclined surface 35a. End surfaces 36b and 36c extend along an imaginary plane intersecting the extending direction of V-groove 31.

Inclined surface 35a of first protruding portion 35 has a fifth portion 351. Fifth portion 351 is adjacent to inclined surface 31a of V-groove 31. Fifth portion 351 includes an edge of inclined surface 35a closer to V-groove 31, that is, a boundary line between inclined surface 35a and inclined surface 31a. The boundary line between inclined surface 35a and inclined surface 31a coincides with a line elongating the boundary line between inclined surface 31a and first surface 33. Similarly, inclined surface 36a of second protruding portion 36 has a sixth portion 361. Sixth portion 361 is adjacent to inclined surface 31b of V-groove 31. Sixth portion 361 includes an edge of inclined surface 36a closer to V-groove 31, that is, a boundary line between inclined surface 36a and inclined surface 31b. The boundary line between inclined surface 36a and inclined surface 31b coincides with a line elongating the boundary line between inclined surface 31b and second surface 34.

Multi-layer film 30 is also disposed on fifth portion 351 and sixth portion 361. Thus, the surface of optical fiber positioning member 3a in fifth portion 351 and sixth portion 361 is formed of coating layer 39. The configurations of metal layer 37, oxide layer 38, and coating layer 39 disposed on fifth portion 351 and sixth portion 361 are the same as the configurations of those disposed inside V-groove 31 in terms of, for example, material, thickness, and manufacturing method.

Inclined surface 35a further has a seventh portion 352. Seventh portion 352 is disposed such that fifth portion 351 is located between V-groove 31 and seventh portion 352. That is, fifth portion 351 is located between seventh portion 352 and V-groove 31. Seventh portion 352 is located opposite to V-groove 31 with respect to fifth portion 351, and is not adjacent to V-groove 31. Inclined surface 36a further has an eighth portion 362. Eighth portion 362 is disposed such that sixth portion 361 is located between V-groove 31 and eighth portion 362. That is, sixth portion 361 is located between eighth portion 362 and V-groove 31. Eighth portion 362 is located opposite to V-groove 31 with respect to sixth portion 361, and is not adjacent to V-groove 31.

Multi-layer film 30 is not disposed on seventh portion 352, and is not disposed on eighth portion 362. Thus, the surface of optical fiber positioning member 3a in seventh portion 352 and eighth portion 362 is formed of substrate 32. In other words, substrate 32 is exposed from multi-layer film 30 in seventh portion 352 and eighth portion 362. When viewed from the normal direction of first surface 33, the boundary line between fifth portion 351 and seventh portion 352 is continuous with the boundary line between first portion 331 and third portion 332. When viewed from the normal direction of second surface 34, the boundary line between sixth portion 361 and eighth portion 362 is continuous with the boundary line between second portion 341 and fourth portion 342.

End surfaces 3aa and 3ab are flat surfaces perpendicular to the extending direction of V-groove 31. End surface 3aa is opposed to end surface 3ab in the extending direction of V-groove 31 and is parallel to end surface 3ab. First surface 33 and second surface 34 are connected to end surface 3aa at the upper end of end surface 3aa. End surface 3ab is flush with end surfaces 35c and 36c to form the same plane. Side surfaces 3ac and 3ad are surfaces along the extending direction of V-groove 31. Side surface 3ac is opposed to side surface 3ad in a direction intersecting with the extending direction of V-groove 31, and is partially parallel to side surface 3ad. Side surfaces 3ac and 3ad connect end surfaces 3aa and 3ab to each other at two side ends of end surfaces 3aa and 3ab. V-shaped cross section grooves 3ae and 3af extending in the extending direction of V-groove 31 are formed on side surfaces 3ac and 3ad, respectively.

Optical fiber positioning member 3a according to the embodiment of the present disclosure and optical fiber fusion splicer 10 including optical fiber positioning member 3a described above provide the following advantageous effects. In optical fiber positioning member 3a of the present embodiment, metal layer 37, oxide layer 38, and coating layer 39 are stacked on substrate 32 at least inside V-groove 31. Coating layer 39 can make less likely for dirt to adhere to the inside of V-groove 31. Oxide layer 38 has a high affinity with coating layer 39 and can be firmly bonded to coating layer 39. However, when oxide layer 38 is brought into contact with ceramic substrate 32, coating layer 39 and oxide layer 38 are easily separated from substrate 32 because the adhesion between oxide and ceramic is low. In optical fiber positioning member 3a of the present embodiment, metal layer 37 containing at least one metal selected from the group consisting of Cr, Ti, Ta, and Nb is disposed between oxide layer 38 and substrate 32. The present inventors have made a prototype of such a structure, and have found that metal layer 37 is less likely to be separated from substrate 32, and oxide layer 38 is less likely to be separated from metal layer 37. That is, in optical fiber positioning member 3a of the present embodiment, dirt can be made less likely to adhere to the inside of V-groove 31, and the effect can be maintained for a long period of time.

As described above, metal layer 37 may be a Cr layer, a Ti layer, a Ta layer, or an Nb layer. With such a configuration, metal layer 37 can be easily formed from a material containing a single element.

As in the present embodiment, metal layer 37 may have a thickness of 50 nm or more and 200 nm or less. Since metal layer 37 has a thickness of 50 nm or more and 200 nm or less, sufficient adhesion can be achieved between substrate 32 and oxide layer 38.

As in the present embodiment, substrate 32 may further have first surface 33 and second surface 34 whose normals are parallel to each other. V-groove 31 may be located between first surface 33 and second surface 34. First surface 33 may have first portion 331 including an edge closer to V-groove 31 on first surface 33. Second surface 34 may have second portion 341 including an edge closer to V-groove 31 on second surface 34. Metal layer 37, oxide layer 38, and coating layer 39 may be also disposed on first portion 331 and second portion 341. In this case, dirt can be made less likely to adhere even in a vicinity of V-groove 31, and it is possible to further prevent dirt from adhering to the inside of V-groove 31.

As in the present embodiment, first surface 33 may further have third portion 332 disposed such that first portion 331 is located between V-groove 31 and third portion 332. Second surface 34 may also further have fourth portion 342 such that second portion 341 is located between V-groove 31 and fourth portion 342. None of metal layer 37, oxide layer 38, and coating layer 39 may be disposed on third portion 332 and fourth portion 342. In this case, the surface of ceramic substrate 32 is exposed. The light reflectance of the ceramic surface is higher than the light reflectance of the stacked structure including metal layer 37, oxide layer 38, and coating layer 39 (mainly depending on the light reflectance of metal layer 37). Thus, the light reflectance of third portion 332 and fourth portion 342 is higher than the light reflectance of V-groove 31, first portion 331, and second portion 341. Thus, when optical fiber F is accommodated in V-groove 31, optical fiber positioning member 3a is illuminated by using a light source, so that the position of V-groove 31 can be easily confirmed by visual observation, and work efficiency can be enhanced.

As in the present embodiment, substrate 32 may further have first surface 33 and second surface 34 between which V-groove 31 is located and whose normals are parallel to each other, first protruding portion 35 formed side by side with first surface 33 in the extending direction of V-groove 31, and second protruding portion 36 formed side by side with second surface 34 in the extending direction of V-groove 31 and disposed such that V-groove 31 is located between first protruding portion 35 and second protruding portion 36. First protruding portion 35 may have inclined surface 35a continuous from V-groove 31. Inclined surface 35a may have fifth portion 351 including an edge close to V-groove 31 on inclined surface 35a. Second protruding portion 36 may have inclined surface 36a continuous from V-groove 31. Inclined surface 36a may have sixth portion 361 including an edge close to V-groove 31 on inclined surface 36a. Metal layer 37, oxide layer 38, and coating layer 39 may be also disposed on fifth portion 351 and sixth portion 361. In this case, dirt can be made less likely to adhere even in a vicinity of V-groove 31, and the it is possible to further prevent dirt from adhering to the inside of V-groove 31. In addition, first protruding portion 35 and second protruding portion 36 respectively have inclined surfaces 35a and 36a continuous from V-groove 31, and thus optical fiber F can be easily accommodated in V-groove 31.

As in the present embodiment, inclined surface 35a of first protruding portion 35 may further have seventh portion 352 disposed such that fifth portion 351 is located between V-groove 31 and seventh portion 352. Inclined surface 36a of second protruding portion 36 may further have eighth portion 362 disposed such that sixth portion 361 is located between V-groove 31 and eighth portion 362. In addition, none of metal layer 37, oxide layer 38, and coating layer 39 may be disposed on seventh portion 352 and eighth portion 362. In this case, as in the case where metal layer 37, oxide layer 38, and coating layer 39 are not disposed in third portion 332 and fourth portion 342, the position of V-groove 31 can be easily confirmed by visual observation, and work efficiency can be enhanced.

As in the present embodiment, oxide layer 38 may be a SiO₂ layer. For example, with such a configuration, oxide layer 38 can be firmly bonded to coating layer 39.

As in the present embodiment, oxide layer 38 may have an anti-reflection function. In this case, the position of V-groove 31 can be easily confirmed by visual observation, and work efficiency can be improved.

As in the present embodiment, coating layer 39 may be formed of fluorine-based resin. For example, such a configuration can make less likely for dirt to adhere to the inside of V-groove 31.

Optical fiber fusion splicer 10 of the present embodiment includes optical fiber positioning member 3a. In optical fiber fusion splicer 10, since dirt is less likely to adhere to the inside of V-groove 31 for positioning optical fiber F to be fusion-spliced, connection failure can be reduced.

### Modification

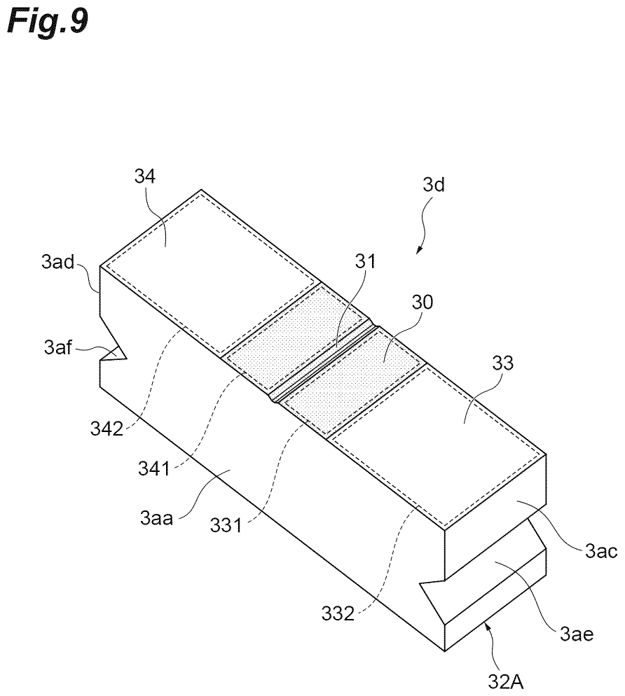

FIG. 9 is an enlarged perspective view showing an optical fiber positioning member 3d according to a modification of the embodiment. Optical fiber positioning member 3d includes a substrate 32A instead of substrate 32 in the above-described embodiment. Substrate 32A is different from substrate 32 in that substrate 32A does not have first protruding portion 35 and second protruding portion 36, but is the same as substrate 32 in other respects. In this manner, even when substrate 32 does not have first protruding portion 35 and second protruding portion 36, dirt can be made less likely to adhere to the inside of V-groove 31, and the effect can be maintained for a long period of time.

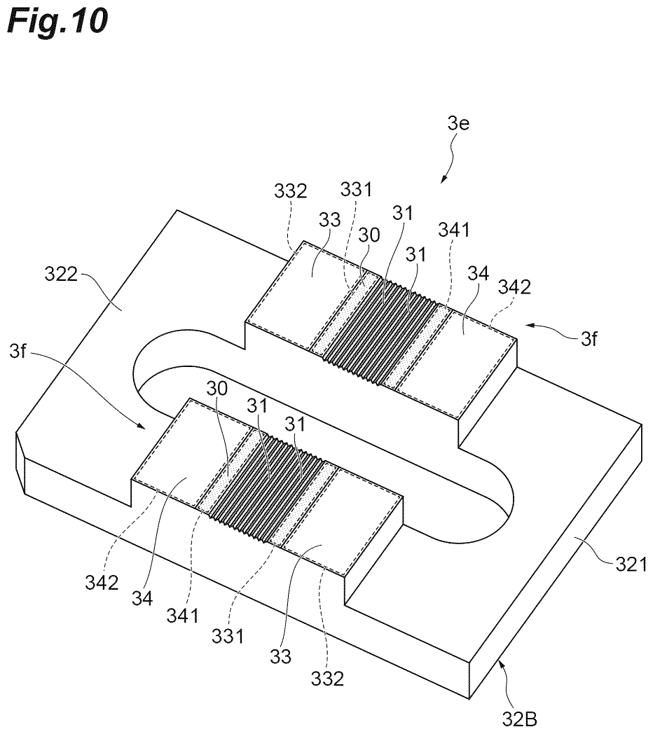

FIG. 10 is an enlarged perspective view showing an optical fiber positioning member 3e according to another modification. In optical fiber positioning member 3e, two positioning portions 3f are arranged in a predetermined direction and integrally formed with each other. Optical fiber positioning member 3e includes a substrate 32B instead of substrate 32 of the above embodiment. Substrate 32B has a planar shape such as a rectangular ring shape. In each of positioning portions 3f, substrate 32B has a plurality of V-grooves 31. The plurality of V-grooves 31 extend straight along the predetermined direction and are parallel to each other. Multi-layer film 30 including metal layer 37, oxide layer 38, and coating layer 39 is disposed in all of V-grooves 31. That is, metal layer 37 is disposed on substrate 32B even inside the plurality of V-grooves 31 to be in contact with substrate 32B. Coating layer 39 inside each of the plurality of V-grooves 31 comes in contact with each of the plurality of optical fibers, thereby positioning each of the plurality of optical fibers.

In each of positioning portions 3f, substrate 32B further has first surface 33 and second surface 34. The configurations of first surface 33 and second surface 34 are the same as those in the above embodiment. Substrate 32B further has portions 321 and 322. Portion 321 is disposed on one side with respect to two positioning portions 3f in a direction intersecting the predetermined direction. Portion 322 is disposed on the other side with respect to two positioning portions 3f in the direction intersecting the predetermined direction. Portions 321 and 322 connect the part of substrate 32B in one positioning portion 3f and the part of substrate 32B in other positioning portion 3f to each other.

As in the present modification, substrate 32B may have a plurality of V-grooves 31 extending in parallel to each other. Metal layer 37 may be disposed on substrate 32B even inside the plurality of V-grooves 31 to be in contact with substrate 32B. Coating layer 39 on the inside of each of the plurality of V-grooves 31 may perform the positioning of each of the plurality of optical fibers by coming into contact with each of the plurality of optical fibers. As described above, even when substrate 32B has a plurality of V-grooves 31, dirt can be made less likely to adhere to the inside of V-grooves 31, and he effect can be maintained for a long period of time. In addition, since substrate 32B has the plurality of V-grooves 31, fusion splicing work of the plurality of optical fibers can be performed at the same time, and thus work efficiency is improved.

While the principles of the present invention have been illustrated and described in the preferred embodiments, it will be appreciated by those skilled in the art that the present invention can be altered in arrangement and detail without departing from such principles. The present invention is not limited to the specific configurations disclosed in the present embodiment. Thus, all modifications and alterations coming from the scope of the appended claims and the scope of their spirit are claimed.

### REFERENCE SIGNS LIST

2 housing
3 fusion splicing unit
3a, 3d, 3e optical fiber positioning member
3aa, 3ab end surface
3ac, 3ad side surface
3ae, 3af groove
3b electrode rod
3c optical fiber holder
3f positioning portion
4 heating device
5 monitor
6 windshield cover
7 power switch
8 splicing start switch
10 optical fiber fusion splicer
30 multi-layer film
31 V-groove
31a, 31b inclined surface
31c curved surface
32, 32A, 32B substrate
33 first surface
34 second surface
35 first protruding portion
35a inclined surface
35b, 35c end surface
36 second protruding portion
36a inclined surface
36b, 36c end surface
37 metal layer
38 oxide layer
39 coating layer
321, 322 portion
331 first portion
332 third portion
341 second portion
342 fourth portion
351 fifth portion
352 seventh portion
361 sixth portion
362 eighth portion
F optical fiber
H imaginary plane

What is claimed is:

1. An optical fiber positioning member installed in an optical fiber fusion splicer and configured to position an optical fiber in a plane intersecting a central axis of the optical fiber, the optical fiber positioning member comprising:
a substrate made of a ceramic and having a V-groove extending straight;
a metal layer disposed on the substrate at least inside the V-groove to be in contact with the substrate and containing at least one metal selected from the group consisting of chromium, titanium, tantalum, and niobium;
an oxide layer disposed on the metal layer to be in contact with the metal layer; and
a coating layer disposed on the oxide layer to be in contact with the oxide layer and having water repellency and oil repellency,
wherein the coating layer inside the V-groove comes in contact with the optical fiber to thereby position the optical fiber.

2. The optical fiber positioning member according to claim 1, wherein the metal layer is a chromium layer, a titanium layer, a tantalum layer, or a niobium layer.

3. The optical fiber positioning member according to claim 1, wherein the metal layer has a thickness of 50 nm or more and 200 nm or less.

4. The optical fiber positioning member according to claim 1,
wherein the substrate further has a first surface and a second surface whose normals are parallel to each other, the V-groove is located between the first surface and the second surface,
the first surface has a first portion including an edge closer to the V-groove on the first surface,
the second surface has a second portion including an edge closer to the V-groove on the second surface, and
the metal layer, the oxide layer, and the coating layer are also disposed on the first portion and the second portion.

5. The optical fiber positioning member according to claim 4,
wherein the first surface further has a third portion disposed such that the first portion is located between the V-groove and the third portion,
the second surface further has a fourth portion disposed such that the second portion is located between the V-groove and the fourth portion, and
none of the metal layer, the oxide layer, and the coating layer is disposed on the third portion and the fourth portion.

6. The optical fiber positioning member according to claim 1,
wherein the substrate further has
a first surface and a second surface between which the V-groove is located and whose normals are parallel to each other,
a first protruding portion formed side by side with the first surface in an extending direction of the V-groove, and
a second protruding portion formed side by side with the second surface in the extending direction and disposed such that the V-groove is located between the first protruding portion and the second protruding portion,
the first protruding portion has an inclined surface continuous from the V-groove, the inclined surface of the first protruding portion has a fifth portion including an edge closer to the V-groove on the inclined surface of the first protruding portion,
the second protruding portion has an inclined surface continuous from the V-groove, the inclined surface of the second protruding portion has a sixth portion including an edge closer to the V-groove on the inclined surface of the second protruding portion, and
the metal layer, the oxide layer, and the coating layer are also disposed on the fifth portion and the sixth portion.

7. The optical fiber positioning member according to claim 6,
wherein the inclined surface of the first protruding portion further has a seventh portion disposed such that the fifth portion is located between the V-groove and the seventh portion,
the inclined surface of the second protruding portion further has an eighth portion disposed such that the sixth portion is located between the V-groove and the eighth portion, and
none of the metal layer, the oxide layer, and the coating layer is disposed on the seventh portion and the eighth portion.

8. The optical fiber positioning member according to claim 1, wherein the oxide layer is a silicon dioxide layer.

9. The optical fiber positioning member according to claim 1, wherein the oxide layer has an anti-reflection function.

10. The optical fiber positioning member according to claim 1, wherein the oxide layer has a thickness of 50 nm or more and 200 nm or less.

11. The optical fiber positioning member according to claim 1, wherein the coating layer is formed of a fluorine-based resin.

12. The optical fiber positioning member according to claim 1, wherein the coating layer has a thickness of 5 nm or more and 30 nm or less.

13. The optical fiber positioning member according to claim 1,
wherein the substrate further has another V-groove extending in parallel with the V-groove,
the metal layer is also disposed on the substrate inside the another V-groove to be in contact with the substrate, and
the coating layer inside the another V-groove comes in contact with another optical fiber to thereby position the another optical fiber.

14. An optical fiber fusion splicer comprising the optical fiber positioning member according to claim 1.
